(19) United States
(12) Patent Application Publication
(10) Pub. No.: US 2013/0236197 A1
(43) Pub. Date: Sep. 12, 2013

(54) POWDER CONTAINER, TONER CARTRIDGE, DEVELOPING DEVICE, PROCESS UNIT, IMAGE FORMING APPARATUS, AND METHOD FOR RECYCLING POWDER CONTAINER

(71) Applicants: Tomofumi Yoshida, Osaka (JP); Tadashi Hayakawa, Kanagawa (JP)

(72) Inventors: Tomofumi Yoshida, Osaka (JP); Tadashi Hayakawa, Kanagawa (JP)

(21) Appl. No.: 13/881,287

(22) PCT Filed: Aug. 15, 2012
(86) PCT No.: PCT/JP12/71117

§ 371 Date: Apr. 24, 2013

(30) Foreign Application Priority Data
Aug. 25, 2011 (JP) 2011-183765
May 15, 2012 (JP) 2012-111654

(51) Int. Cl. G03G 15/00; G03G 15/08; G03G 21/18

(52) U.S. Cl. CPC G03G 15/0834
USPC 399/12; 399/109; 399/262; 399/111

(57) ABSTRACT

A powder container includes a housing configured to house powder therein, the housing including a hole connecting between inside and outside of the housing. The powder container also includes a cover member detachably attached to the housing to close the hole; and a signal exchanging unit configured to transmit and receive a signal to and from an apparatus to which the powder container is mounted. The signal exchanging unit is provided in the cover member.

### TECHNICAL FIELD

The present invention relates to a powder container for housing powder therein, a toner cartridge, a developing device, a process unit, an image forming apparatus, and a method for recycling the powder container.

### BACKGROUND ART

Known is a technique that configures an electrophotographic image forming apparatus such that a detachable component which is a toner cartridge, a developing device, or a process unit in which a toner cartridge, a developing device, a photosensitive element, and the like are integrated is detachably mountable in an image forming apparatus. The image forming apparatus is, for example, a copier, a printer, a facsimile, or a multifunction peripheral (MFP) having multiple functions of these. This technique is advantageous in that a user or the like can perform maintenance of the apparatus easily by replacing the detachable component and adopted by a large number of products because of this advantage.

Some type of the detachable component which is a toner cartridge, a developing device, or a process unit includes an information storage medium such as an IC chip (IC tag) on an outer surface of a housing which is a part of the detachable component (see Japanese Patent Application Laid-open No. 2010-276779). Stored in the IC chip serving as the information storage medium is information about a toner amount, driven-rotated time or a driven distance for use in managing wear or degradation of a component such as a developing roller or a photosensitive element resulting from use, the date of manufacture and an identifying number of the detachable component, an identification number of the image forming apparatus in which the detachable component is to be mounted, the date on which the detachable component is mounted, the date on which a usable life of the detachable component has ended, and the like. These pieces of information are stored in the IC chip or updated so that image quality is maintained and a user is informed about when the detachable component needs replacing.

Some type of the detachable component includes a toner sensor on the housing for detecting an amount of toner (including toner containing carrier particles) by detecting a pressure change or a magnetic field change. Some type of the toner sensor is an optical toner sensor that includes a light guide member, which is a transparent plastic member arranged in the housing and a part of which is removed to form a blank portion. The optical toner sensor detects toner that is present in the blank portion with light emitted from outside (when toner is present, the light is blocked, while when no toner is present, the light can pass through).

Meanwhile, environmental actions are taken globally, notably by developed countries, in recent years. Manufacturers of image forming apparatuses are recycling exhausted detachable components such as toner cartridges, developing devices, and processing units that have become toner depletion as one of the environmental actions. The recycling is performed by collecting the exhausted detachable components from users, performing necessary processes on them, and putting them into the market again.

Recycling of the detachable component such as a toner cartridge generally includes a cleaning process that is performed first. The cleaning process includes unsealing a fill port in a housing or boring an additional hole in the housing, and delivering highly-compressed air into the housing through the hole or the fill port using an air gun or the like to discharge residual toner from the housing to the outside. The housing is refilled with toner injected through the fill port or the bored hole. The fill port or the hole is sealed with a seal (see Japanese Patent Application Laid-open No. 2002-251119).

However, when an information storage medium such as an IC chip (IC tag) is arranged on the detachable component such as a toner cartridge, the information storage medium can be soiled with toner during the cleaning process as a result that, for example, the toner discharged to the outside of the housing unintentionally sticks to the information storage medium or that an operator unintentionally touches the information storage medium with a hand to which toner is sticking. If the information storage medium is soiled with toner, contact failure can occur at a connection terminal of the information storage medium, resulting in that information cannot be read from or written to the information storage medium accurately. Therefore, in a case where the information storage medium should be soiled with toner, an additional work of cleaning the information storage medium becomes necessary.

The same holds true for a toner sensor (hereinafter, “piezoelectric sensor”) that detects a pressure change or a sensor (hereinafter, “magnetic sensor”) that detects a magnetic field change arranged on the detachable component such as a toner cartridge. If the sensor is soiled during cleaning, contact failure can occur at a terminal on the sensor.

Furthermore, there can also arise a problem that static electricity generated by air blasting with the air gun during cleaning can damage an electronic component of the information storage medium, the piezoelectric sensor, or the magnetic sensor and make the electronic component unreusable.

Meanwhile, unlike the piezoelectric sensor and the magnetic sensor described above, the light guide member of the optical sensor is free from risk of a contact failure. However, the light guide member generally occupies a relatively large space in the housing. Accordingly, the light guide member can hinder cleaning of the housing or toner filling when the light guide member remains attached.

Therefore, there is a need for a recycling process of a powder container on which an electronic component or an optical component is arranged and that can be recycled easily and efficiently, a toner cartridge, a developing device, a process unit, an image forming apparatus, each including the powder container, and a method for recycling the powder container.

### DISCLOSURE OF INVENTION

It is an object of the present invention to at least partially solve the problems in the conventional technology.

According to an embodiment, there is provided a powder container that includes a housing configured to house powder therein, the housing having a hole connecting between inside and outside of the housing; a cover member detachably attached to the housing to close the hole; and a signal exchanging unit configured to transmit and receive a signal to and from an apparatus to which the powder container is mounted, the signal exchanging unit being provided in the cover member.

According to another embodiment, there is provided a toner cartridge that is detachably mounted in an image forming apparatus and includes the powder container according to the above embodiment, the powder being toner.

According to still another embodiment, there is provided a developing device that is detachably mounted in an image forming apparatus and includes a powder container according to the above embodiment, the powder being toner; and a developing unit configured to develop a latent image on a latent image carrier using the toner in the powder container.

According to still another embodiment, there is provided a process unit that is detachably mounted on an image forming apparatus and includes a latent image carrier configured to carry a latent image thereon; a powder container according to claim 1, the powder being toner; and a developing unit configured to develop a latent image on the latent image carrier using the toner in the powder container.

According to still another embodiment, there is provided an image forming apparatus that includes the powder container according to the above embodiment, the toner cartridge according to the above embodiment, the developing device according to the above embodiment, or the process unit according to the above embodiment.

According to still another embodiment, there is provided a method for recycling a powder container that includes a housing configured to house powder therein, the housing having a hole connecting between inside and outside of the housing, a cover member detachably attached to the housing to close the hole, and a signal exchanging unit configured to transmit and receive a signal to and from an apparatus to which the powder container is mounted, the signal exchanging unit being provided in the cover member. The method includes detaching the cover member from the exhausted powder container; cleaning inside the housing; filling the housing with powder through the hole; and closing the hole with the cover member.

The above and other objects, features, advantages and technical and industrial significance of this invention will be better understood by reading the following detailed description of presently preferred embodiments of the invention, when considered in connection with the accompanying drawings.

### BRIEF DESCRIPTION OF DRAWINGS

FIG. 1 is a schematic configuration diagram of an image forming apparatus according to a first embodiment of the present invention;

FIG. 2 is a schematic configuration diagram of a process unit according to the first embodiment;

FIG. 3 is an external view of the process unit;

FIG. 4 is an enlarged view of a relevant portion of the process unit;

FIG. 5 is another enlarged view of the relevant portion of the process unit;

FIG. 6 is a schematic configuration diagram of a process unit according to a second embodiment of the present invention;

FIG. 7A is a side view of a cover member;

FIG. 7B is a view of the cover member as viewed from an inner side;

FIG. 8 is a diagram for explaining how to attach the cover member;

FIG. 9 is a diagram illustrating the process unit according to the second embodiment in a state where the process unit is mounted in an image forming apparatus;

FIG. 10 is a schematic configuration diagram of a process unit according to a third embodiment of the present invention;

FIG. 11 is a diagram illustrating the configuration of an optical detector;

FIG. 12 is a diagram illustrating a modification of the cover member;

FIG. 13 is a schematic configuration diagram illustrating an example where the configuration of the present invention is applied to a process unit for a layout that lays a plurality of process units in a vertically stacked arrangement; and

FIG. 14 is a schematic configuration diagram illustrating an example where the configuration of the present invention is applied to a process unit for a layout that lays a plurality of process units in a side-by-side arrangement.

### BEST MODE(S) FOR CARRYING OUT THE INVENTION

Exemplary embodiments of the present invention are described below with reference to the accompanying drawings. In the drawings for describing the present invention, elements such as members or components that are identical in function or shape are indicated by a same reference numeral and/or a symbol as far as they are distinguishable, and repeated description is omitted.

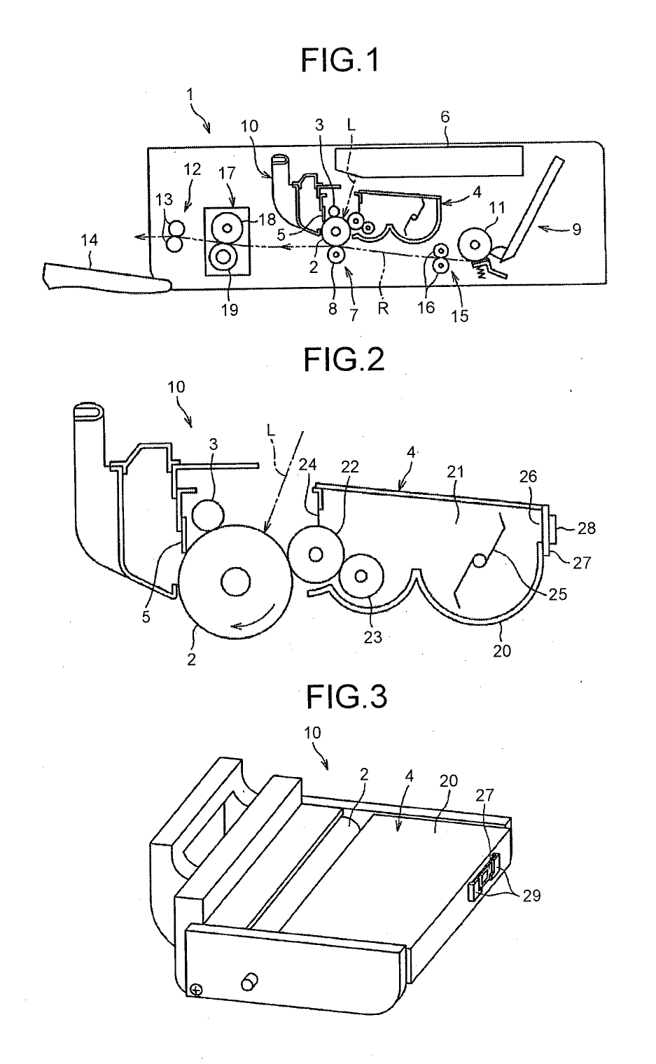

First, an overall configuration and operations of an image forming apparatus according to a first embodiment of the present invention are described with reference to FIG. 1.

An image forming apparatus 1 illustrated in FIG. 1 is a monochrome-image forming apparatus. A process unit 10 is detachably mounted as an image forming unit on a substantially center portion of the body of the image forming apparatus 1. The process unit 10 includes a drum-like photosensitive element 2 serving as a latent-image carrier, an electrostatic charging device that includes a charging roller 3 that electrostatically charges a surface of the photosensitive element 2 and the like, a developing device 4 that develops a latent image on the photosensitive element 2 (into a visible image), and a cleaning device including a cleaning blade 5 and the like for cleaning the surface of the photosensitive element 2.

Arranged above the process unit 10 is an exposure device 6 that exposes the surface of the photosensitive element 2. The exposure device 6 includes a light source, a polygon mirror, an f-theta lens, and a reflection mirror. The exposure device 6 emits laser light L onto the surface of the photosensitive element 2 according to image data.

Arranged below the process unit 10 is a transfer device 7 that includes a transfer roller 8 serving as a transfer unit that transfers an image onto a paper sheet or the like. The transfer roller 8 is arranged so as to contact the photosensitive element 2. A transfer bias voltage is to be applied from a power source (not shown) to the transfer roller 8.

Arranged in a right portion of the image forming apparatus 1 in FIG. 1 is a sheet feeding device 9 that includes a sheet feeding roller 11 serving as a feeding unit that feeds a sheet recording medium such as a paper sheet or a transparency.

Arranged in a left portion of the image forming apparatus 1 in FIG. 1 are a sheet discharging device 12 including a pair of sheet discharging rollers 13 serving as a discharging unit that discharges a sheet or the like to the outside of the apparatus, and a sheet discharge tray 14 on which sheets or the like discharged to the outside of the apparatus are to be stacked.

A conveying path R for conveying a sheet or the like from the sheet feeding device 9 to the sheet discharging device 12 is formed in the image forming apparatus 1. A conveying device 15 is arranged on the conveying path R at a position upstream of a transfer nip which is provided at a contact portion between the photosensitive element 2 and the transfer roller 8. The conveying device 15 includes a pair of registration rollers 16 serving as a conveying element that conveys the sheet or the like to the transfer nip at timing appropriate for conveyance.

A fixing device 17 is arranged on the conveying path R at a position downstream of the transfer nip. The fixing device 17 includes a fixing roller 18 and a pressing roller 19 arranged in contact with each other. A halogen heater (not shown) serving as a heat source is arranged in the fixing roller 18.

The image forming apparatus 1 operates as described below.

When an image forming operation is started, the photosensitive element 2 is rotated clockwise in FIG. 1, and the surface of the photosensitive element 2 is uniformly electrostatically charged by the charging roller 3 in predetermined polarity. Subsequently, the exposure device 6 illuminates the charged surface of the photosensitive element 2 with the laser light L according to image data about a document read in by an image reader (not shown). As a result, an electrostatic latent image is formed on the surface of the photosensitive element 2. The developing device 4 supplies toner onto the electrostatic latent image formed on the photosensitive element 2. Consequently, the electrostatic latent image is developed into a toner image (visible image).

Meanwhile, the sheet feeding roller 11 starts rotating in the sheet feeding device 9 to deliver a sheet to the conveying path R from stacked sheets. The sheet delivered onto the conveying path R abuts on the pair of registration rollers 16 to be temporarily stopped. As a result, skew of the sheet is corrected. Thereafter, the pair of registration rollers 16 is rotated again to convey the sheet to the transfer nip between the photosensitive element 2 and the transfer roller 8 at timing adjusted for the toner image formed on the photosensitive element 2.

At this time, a transfer bias voltage that is opposite in polarity to the polarity in which the toner image on the photosensitive element 2 is charged is applied to the transfer roller 8. A transfer electric field generated by the transfer bias voltage causes the toner image on the photosensitive element 2 to be transferred onto the sheet. The sheet onto which the toner image is transferred is conveyed to the fixing device 17. The toner is fused while the sheet passes through a fixing nip where the fixing roller 18 and the pressing roller 19 contact each other. As a result, the toner image is fixed onto the sheet. The sheet is thereafter discharged to the outside of the image forming apparatus 1 by the pair of sheet discharging rollers 13 and stacked on the sheet discharge tray 14.

The surface of the photosensitive element 2 from which the toner image has been transferred is cleaned by the cleaning blade 5 and electrostatically charged again by the charging roller 3 for latent image formation as preparation for a next exposure.

Meanwhile, in the first embodiment, the conveying path R for a paper sheet or the like is laid substantially horizontally so that the image forming apparatus 1 can have a thin profile for miniaturization of the apparatus. Furthermore, arranging the conveying path R substantially horizontally makes the image forming apparatus 1 less prone to paper jam with various types of recording media.

FIG. 2 is a schematic configuration diagram of the process unit 10.

The developing device 4 included in the process unit 10 is described below with reference to FIG. 2.

As illustrated in FIG. 2, the developing device 4 includes a housing 20, a developing roller 22, a supplying roller 23, a developing blade 24, and an agitator 25. The housing 20 internally includes a developer housing unit 21 for housing toner serving as a developer (powder for use in image forming) therein. The developing roller 22 serves as a developing unit that carries toner thereon and develops the latent image on the photosensitive element 2. The supplying roller 23 serves as a supplying member that supplies toner to the developing roller 22. The developing blade 24 serves as a restricting member that restricts an amount of toner carried by the developing roller 22. The agitator 25 serves as an agitating member that stirs the toner in the developer housing unit 21.

The supplying roller 23 is in contact with the developing roller 22. When the developing roller 22 and the supplying roller 23 start rotating as the image forming operation is started, toner is supplied by the supplying roller 23 onto the surface of the developing roller 22 to be carried thereon. A contact portion between the developing roller 22 and the developing blade 24 restricts a thickness of a layer of the toner carried on the developing roller 22 when the toner layer passes through the contact portion. Thereafter, when the toner on the developing roller 22 is conveyed to a contact portion (developing area) where the toner contacts the photosensitive element 2, the toner is electrostatically transferred onto the electrostatic latent image on the photosensitive element 2 to form a toner image. The agitator 25 is rotated to thereby stir and simultaneously convey the toner in the developer housing unit 21 toward the supplying roller 23.

As illustrated in FIG. 2, a hole 26 that connects between the inside and the outside of the housing 20 is bored in the housing 20. This hole 26 is provided for toner filling, and closed (sealed) with a plate-like cover member 27 after toner filling. An IC chip (IC tag) 28 serving as the information storage medium is arranged on an outer surface of the cover member 27.

The IC chip 28 stores at least information about the toner housed in the housing 20. Examples of the information about the toner include a toner amount (remaining amount of the toner) and a color of the toner. Other examples of the information that can be stored in the IC chip 28 include information about driven-rotated time or a driven distance for managing wear or degradation of a component such as the developing roller 22 or the photosensitive element 2 resulting from use, the date of manufacture and an identification number of the process unit 10, an identification number of the image forming apparatus 1, the date on which the process unit 10 is mounted, and the date on which a usable life of the process unit 10 has ended.

An information reader (not shown) that reads information stored in the IC chip 28 is arranged on the body of the image forming apparatus 1. Mounting the process unit 10 in the image forming apparatus 1 brings the IC chip 28 on the process unit 10 and the information reader on the image forming apparatus 1 into electrical connection via connecting terminals. As a result, information reading from and information writing to the IC chip 28 becomes possible.

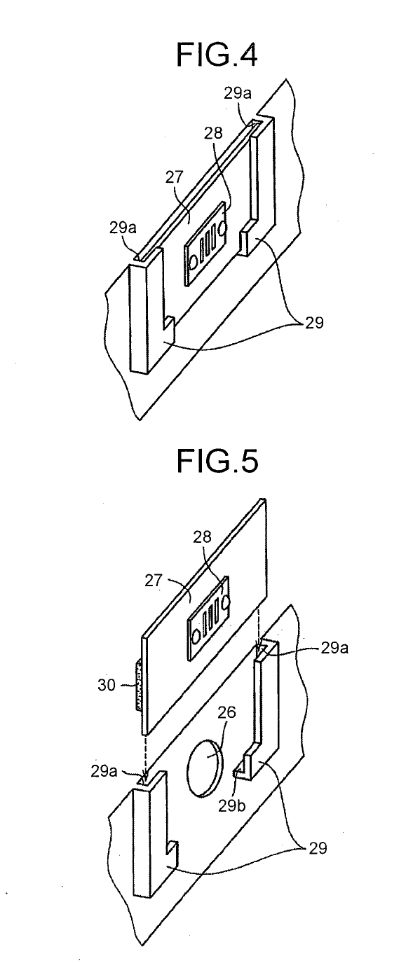

FIG. 3 is an external view of the process unit 10. FIGS. 4 and 5 are enlarged views of a relevant portion of the process unit 10.

As illustrated in FIG. 3, the cover member 27 is detachably attached to the housing 20 via a holder 29 arranged on the outer side of the housing 20.

More specifically, as illustrated in FIGS. 4 and 5, the holder 29 has a pair of grooves 29a into which the cover member 27 can be inserted. Inserting the cover member 27 into these grooves 29a brings a bottom end of the cover member 27 into contact with bottoms 29b (see FIG. 5) of the grooves 29a so that the cover member 27 is held by the holder 29.

As illustrated in FIG. 5, a seal 30 made of polyurethane foam or the like is arranged on a back surface (surface that faces the housing 20) of the cover member 27. This seal 30 is as large as to cover the hole 26. In a state where the cover member 27 is inserted into the holder 29, the seal 30 seals the hole 26 to prevent toner leakage through the hole 26. Furthermore, in this state, the seal 30 is compressed between the cover member 27 and the housing 20, and a resilience of the compressed seal 30 presses the cover member 27 against the grooves 29a of the holder 29. This pressing force holds the cover member 27 in a manner to prevent the cover member 27 from falling out of the grooves 29a. The cover member 27 can be detached from the holder 29 by sliding the cover member 27 upward while applying a force greater than the resilience of the seal 30 onto the cover member 27 from an outer side of the cover member 27 toward the housing 20.

A method for recycling the process unit 10 according to the first embodiment is described below.

When the process unit 10 has become exhausted because toner is consumed to toner depletion, the exhausted process unit 10 is collected from a user. Thereafter, cleaning for discharging deteriorated residual toner from the housing 20 is performed. Before the cleaning is performed, the cover member 27 on which the IC chip (IC tag) 28 is arranged is detached from the housing 20. The cover member 27 is stored in such a place where toner scattered during the cleaning will not stick to the cover member 27.

Thereafter, the cleaning of the inside of the housing 20 is performed. The cleaning includes, as a step to be performed first, vibrating the process unit 10 with the hole 26 of the housing 20 facing downward to discharge the residual toner from the housing 20 through the hole 26 to a certain extent. Subsequently, toner still remaining in the housing 20 is blown out through the hole 26 by delivering highly-compressed air into the housing 20 through the hole 26 with an air gun or the like.

When the cleaning is completed, the housing 20 is refilled with new toner injected through the hole 26. The hole 26 is sealed by attaching the stored cover member 27 onto the housing 20. The information stored in the IC chip 28 is overwritten or partially updated. Recycling of the process unit 10 is completed by performing processes described above.

Meanwhile, an approach of boring a new hole in the housing 20 and discharging the residual toner through the new hole can be taken to perform the cleaning of the housing 20. However, this approach disadvantageously involves careful boring in a manner not to damage internal components and also requires sealing the bored hole. Meanwhile, it is necessary to temporarily disassemble a component from the process unit 10 in a case where highly-compressed air cannot be delivered into the housing 20 through the hole 26 or the like which is provided for toner filling because the air gun interferes with the component. In such a case, preparation for the cleaning requires a considerable amount of work because it becomes necessary to perform not only disassembling the component but also managing the disassembled component.

In contrast, in the first embodiment of the present invention, the hole 26 which is provided as the fill port (or a discharge port) in advance is utilized. Accordingly, the cleaning of the inside of the housing 20 can be performed without neither boring a new hole in the housing 20 nor disassembling the process unit 10. As a result, the cleaning can be performed efficiently.

As described above, according to the method for recycling the process unit 10 according to the first embodiment, the cover member 27 on which the IC chip (IC tag) 28 is arranged is detached from the housing 20 and stored before the cleaning of the housing 20 is performed. Accordingly, sticking of scattered toner or toner that has stuck to an operator's hand to the IC chip (IC tag) 28 during the cleaning is prevented. This eliminates the need of additional cleaning of the IC chip (IC tag) 28 soiled with toner, thereby increasing efficiency of the cleaning. Furthermore, even when a large amount of static electricity is built by air blasting with the air gun during the cleaning, the IC chip (IC tag) 28 is unaffected by the static electricity and therefore will not become damaged. This allows reuse of the IC chip (IC tag) 28 and leads to reduction in recycling cost.

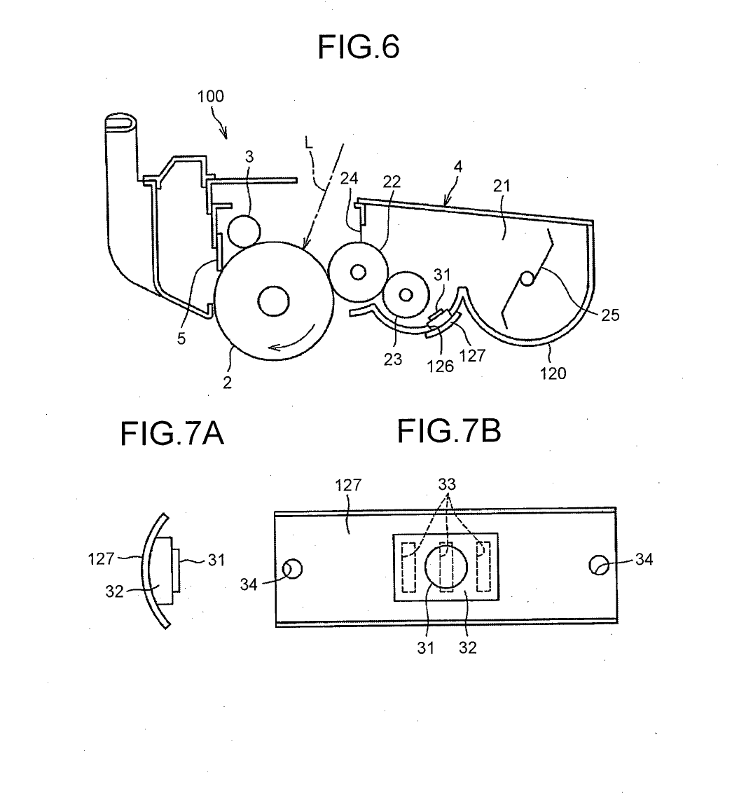

FIG. 6 is a schematic configuration diagram of a process unit 100 according to a second embodiment of the present invention.

Only portions of the configuration of the process unit 100 according to the second embodiment that differ from those of the first embodiment are described below.

The process unit 10 according to the first embodiment includes the IC chip (IC tag) 28 that provides information about presence/absence (remaining amount) of toner in the housing. In contrast, the process unit 100 according to the second embodiment illustrated in FIG. 6 includes a piezoelectric sensor 31 as a detector that detects presence/absence (remaining amount) of toner. The piezoelectric sensor 31 is arranged in a housing 120 of the process unit 100 and detects whether toner is present in the housing 120 based on a load of toner imposed on an end surface of the piezoelectric sensor 31.

The piezoelectric sensor 31 is arranged on the inner surface of a cover member 127 that is detachably attachable to the housing 120. As illustrated in FIG. 6, the piezoelectric sensor 31 is exposed to the inside of the housing 120 through a hole 126 bored in the housing 120 in a state where the cover member 127 is attached to the housing 120. This hole 126 also functions as the hole for cleaning of the housing 120 and toner filling.

FIG. 7A is a side view of the cover member 127 illustrated in FIG. 6. FIG. 7B is a view of the cover member 127 as viewed from the internal side.

As illustrated in FIGS. 7A and 7B, the piezoelectric sensor 31 is attached to the inner surface of the cover member 127 via an IC substrate 32. A plurality of slits 33 are provided in the cover member 127 at a portion where the IC substrate 32 is attached. An electrical contact on the IC substrate 32 is exposed to the outside through the slits 33. A screw hole 34 is bored in each of longitudinally opposite end portions of the cover member 127.

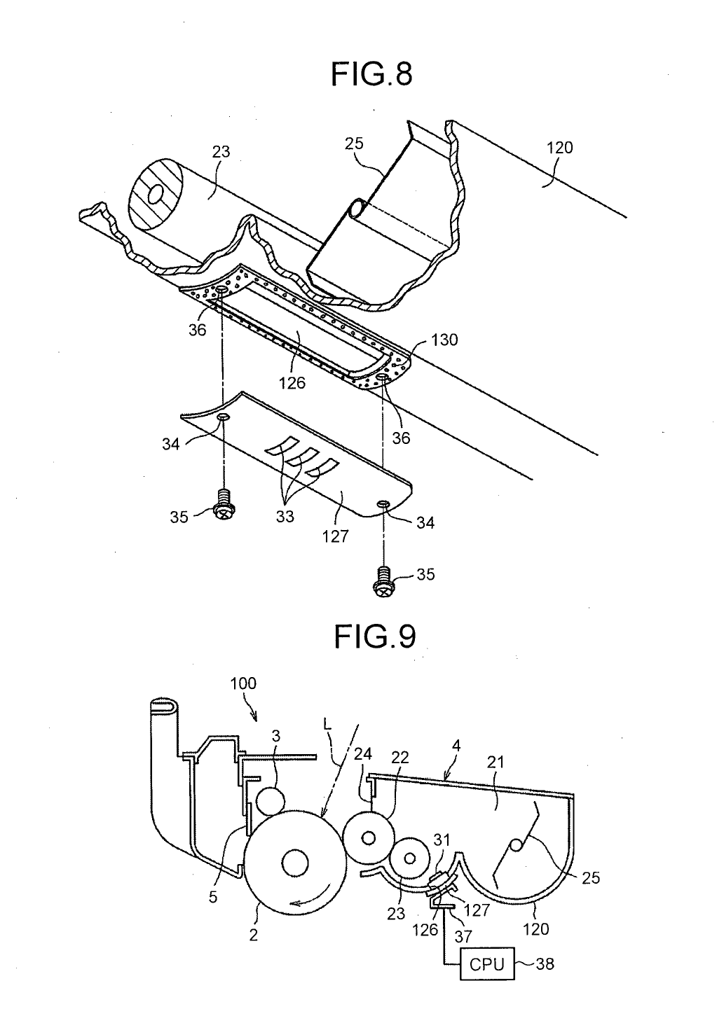

As illustrated in FIG. 8, the cover member 127 is attached to the housing 120 by inserting screws 35 into the screw holes 34 in the cover member 127, and tightening the screws 35 into screw holes 36 in the housing 120. The seal 130 made of a sponge or the like is arranged around the hole 126 bored in the housing 120. When the cover member 127 is attached to the housing 120, the cover member 127 and the seal 130 seal the hole 126. As a result, toner leakage through the hole 126 is prevented.

FIG. 9 is a diagram illustrating the process unit 100 according to the second embodiment illustrated in FIG. 6 in a state where the process unit 100 is mounted in the image forming apparatus 1.

As illustrated in FIG. 9, mounting the process unit 100 in the image forming apparatus 1 brings the electrical contact on the IC substrate 32 into contact with an electrical contact 37 on the body of the image forming apparatus 1, thereby electrically connecting the piezoelectric sensor 31 to a CPU 38 in the image forming apparatus 1. In this example, the electrical contact 37 on the body of the image forming apparatus 1 is made up of three flat springs and contacts the electrical contact on the IC substrate 32 through the slits 33 provided in the cover member 127. When electrical connection is established between the piezoelectric sensor 31 and the CPU 38, the CPU 38 can receive an electrical signal output from the piezoelectric sensor 31. The CPU 38 determines presence or absence of toner based on the electrical signal. When the CPU 38 determines that there is no toner, a notifying element (not shown) issues a notifying signal according to an instruction fed from the CPU 38.

Subsequently, a method for recycling the process unit 100 according to the second embodiment illustrated in FIG. 6 is described below.

The process unit 100 is to be recycled as follows. First, as with the recycling method described above, the cover member 127 is detached from the housing 120 and stored. After cleaning of the inside of the housing 120, the housing 120 is refilled with new toner injected through the hole 126. The hole 126 is sealed by attaching the cover member 127 onto the housing 120.

Also in this recycling, the cover member 127 is detached from the housing 120 and stored before the cleaning of the housing 120 is performed. Accordingly, sticking of toner to the piezoelectric sensor 31 during the cleaning is prevented. This eliminates the need of additional cleaning of the piezoelectric sensor 31 soiled with toner, thereby increasing efficiency in the cleaning. Furthermore, even when a large amount of static electricity is built by air blasting with an air gun during the cleaning, the piezoelectric sensor 31 is unaffected by the static electricity and therefore will not become damaged. This allows reuse of the piezoelectric sensor 31 and leads to reduction in recycling cost.

In the configuration illustrated in FIG. 6, a magnetic sensor may be arranged on the cover member 127 as the detector for detecting presence/absence of toner in lieu of the piezoelectric sensor 31. Among magnetic sensors, a magnetic sensor that detects a two-component developer made up of a carrier and toner is capable of detecting a toner concentration in addition to detecting presence/absence of toner. Also in this case, toner sticking to the magnetic sensor or a damage to the magnetic sensor by static electricity built during the cleaning of the housing 120 can be prevented by arranging the magnetic sensor on the cover member 127 as in the case where the piezoelectric sensor is used.

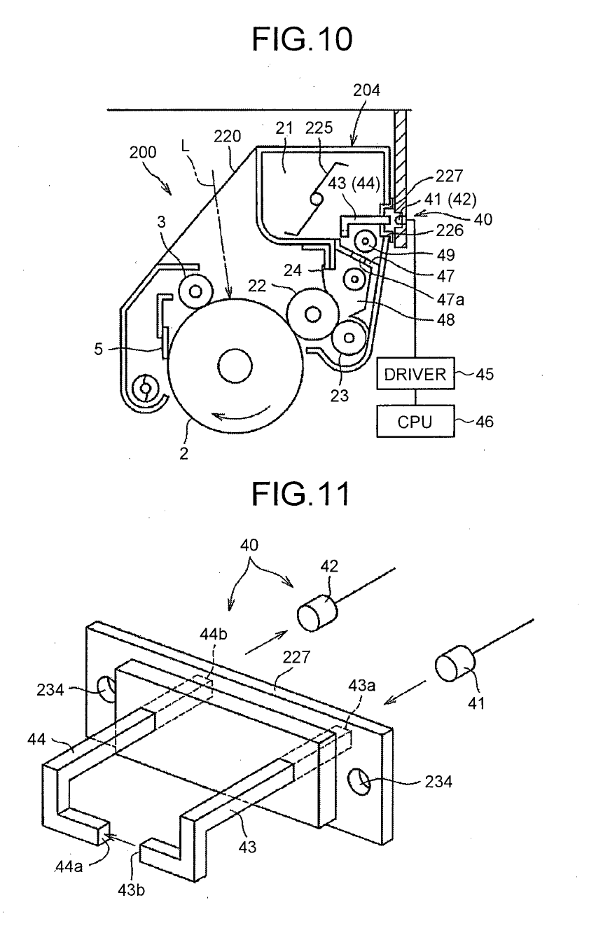

FIG. 10 is a schematic configuration diagram of a process unit 200 according to a third embodiment of the present invention.

Only portions of the configuration of the process unit 200 according to the third embodiment that differ from those of the first and second embodiments are described below.

In the third embodiment, an optical detector is used as the detector that detects presence/absence (remaining amount) of toner.

As illustrated in FIG. 11, an optical detector 40 includes a light-emitting element 41 for emitting light, a light-receiving element 42 for receiving light, and a first light guide member 43 and a second light guide member 44 for guiding the light emitted from the light-emitting element 41 to the light-receiving element 42. The light guide members 43 and 44 are made of a transparent plastic or the like and arranged on a cover member 227 that is detachably attachable to a housing 220. The light-emitting element 41 and the light-receiving element 42 are arranged in the image forming apparatus 1. As illustrated in FIG. 10, the image forming apparatus 1 includes a driver 45 that causes the light-emitting element 41 to emit light at regular intervals and a CPU 46 that determines presence/absence of toner based on an output value of the light-receiving element 42.

A hole 226 is bored in the housing 220 at a portion where the cover member 227 is to be attached. As illustrated in FIG. 10, the light guide members 43 and 44 are arranged in the housing 220 through the hole 226 in the state where the cover member 227 is attached to the housing 220. As in the case of the first and second embodiments, this hole 226 also functions as the hole for cleaning of the housing 220 and toner filling.

As illustrated in FIG. 11, an externally-exposed end portion of the light guide member 43 and that of the light guide member 44 face the light-emitting element 41 and the light-receiving element 42, respectively, in the state where the process unit 200 is mounted in the image forming apparatus 1. In this state, light emitted from the light-emitting element 41 enters an end 43a of the first light guide member 43 and exits from another end 43b on the other side of the first light guide member 43 as illustrated in FIG. 11. The light that exits the end 43b of the first light guide member 43 enters an end 44a, which faces the end 43b, of the second light guide member 44 and exits from another end 44b on the opposite side of the second light guide member 44 to reach the light-receiving element 42.

When the amount of toner in the housing 220 is sufficient, toner present between the ends 43b and 44a that face each other of the first light guide member 43 and the second light guide member 44 blocks light. Therefore, light does not reach the light-receiving element 42. On the other hand, when toner is consumed for printing or the like and a toner level has dropped to be lower than the position of the light guide members 43 and 44, toner is no more present between the ends 43b and 44a that face each other of the first light guide member 43 and the second light guide member 44. Therefore, light reaches the light-receiving element 42. When the CPU 46 receives a signal (output value) output from the light-receiving element 42 in this state, the CPU 46 determines that the toner amount is below a predetermined amount. When the CPU 46 has determined that the toner amount is below the predetermined amount, a notifying element (not shown) issues a notification about low toner.

In the third embodiment illustrated in FIG. 10, an agitator 225 rotates such that a portion of the agitator 225 periodically passes through a clearance between the ends 43b and 44a that face each other of the first light guide member 43 and the second light guide member 44 to push out toner present between the ends 43b and 44a. A developing device 204 illustrated in FIG. 10 is a developing device that adopts a vertically-stacking layout in which the developer housing unit 21 is arranged above the developing roller 22 and the supplying roller 23. A partition 47 divides the developing device 204 into a developing unit 48 in a lower portion and the developer housing unit 21 in an upper portion. The toner housed in the developer housing unit 21 is stirred and delivered to a screw conveyor 49 by the agitator 225. The toner is further conveyed by the rotating screw conveyor 49 toward an axial end of the developer housing unit 21 to be supplied to the developing section 48 through a hole 47a bored in the partition 47.

Similarly to the cover member 127 illustrated in FIG. 8, a cover member 227 illustrated in FIG. 11 has the screw holes 234 for screw fastening. The seal 130 made of a sponge or the like is arranged around the hole 226 bored in the housing 220 (see FIG. 8) as in the case of the embodiments described above.

Subsequently, a method for recycling the process unit 200 according to the third embodiment illustrated in FIG. 10 is described below.

The process unit 200 according to the third embodiment is to be recycled fundamentally in a manner similar to those of the first and second embodiments. More specifically, after detaching the cover member 227 from the housing 220 and storing the cover member 227, cleaning of the inside of the housing 220 is performed. Thereafter, the housing 220 is refilled with new toner injected through the hole 226, and the cover member 227 is attached to seal the hole 226.

According to this method, the cover member 227 is detached from the housing 220 before the cleaning of the housing 220 is performed so that the light guide members 43 and 44 temporarily evacuate from the inside of the housing 220. As a result, such a situation that the light guide members 43 and 44 hinder the cleaning and toner filling that follows the cleaning is prevented. The cleaning and the toner filling are therefore facilitated.

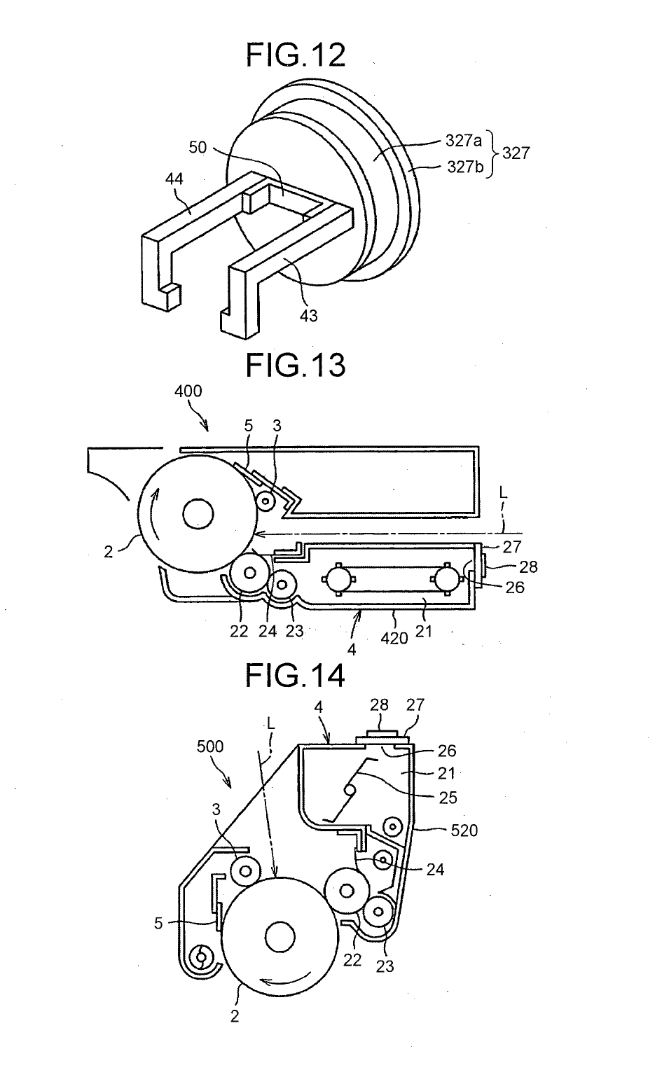

FIG. 12 illustrates a modification of the cover member.

A cover member 327 illustrated in FIG. 12 includes a cylindrical insertion portion 327a that is to be inserted into a circular hole (not shown) bored in the housing 220 and a flange portion 327b arranged on a rim of the insertion portion 327a. The cover member 327 is made of a soft material such as polypropylene. When the cover member 327 is attached to the housing 220, the insertion portion 327a is press-fit into the hole to thereby seal the hole 226. Therefore, this modification eliminates the need of arranging a seal around the hole 226.

Indicated by reference numeral 50 in FIG. 12 is a support member that is arranged on the cover member 327 to prevent tilt of the light guide members 43 and 44. FIG. 12 illustrates the configuration in which the light guide members 43 and 44 are arranged on the cover member 327 made of a soft material. Alternatively, the IC chip (IC tag), the piezoelectric sensor, the magnetic sensor, or the like can be arranged on the cover member 327 similar to that illustrated in FIG. 12. The insertion portion 327a can have a shape other than the circular shape depending on a shape of the hole into which the insertion portion 327a is to be inserted.

It should be understood that the present invention is not limited to the embodiments discussed above, and various modifications can be made within the scope of the present invention. The embodiments have been described by way of the examples in each of which the configuration of the present invention is applied to the process unit to be mounted on the monochrome-image forming apparatus illustrated in FIG. 1. However, the configuration of the present invention is also applicable to a process unit to be mounted on a printer, a copier, a facsimile, or an MFP having multiple functions of these.

FIGS. 13 and 14 illustrate examples in each of which the configuration of the present invention is applied to a process unit for a color-image forming apparatus.

Illustrated in FIG. 13 is a process unit 400 for a layout that lays a plurality of process units in a vertically stacked arrangement (vertical arrangement). Illustrated in FIG. 14 is a process unit 500 for a layout that lays a plurality of process units in a side-by-side arrangement (horizontal arrangement).

The process unit 400 illustrated in FIG. 13 and the process unit 500 illustrated in FIG. 14 can also yield operation advantage similar to that of the embodiments when the IC chip (IC tag) 28, or an electronic component (a piezoelectric sensor, a magnetic sensor, or the like) or an optical component (a light guide member or the like) that forms the various types of detector for detecting presence/absence of toner is arranged on the cover member 27 that is detachably attached to respective housings 420 and 520.

Application of the configuration of the present invention is not limited to the process units 10, 100, 200, 400, and 500 into which the photosensitive element 2, the developing device 4, and the like are combined. The configuration is also applicable to the developing device 4 that is separated from the photosensitive element 2, and a toner cartridge which is the developer housing unit 21 (toner container) and the like separated from the developing device 4.

More specifically, referring to FIG. 2, the developing device 4 can be configured to be singly detachably attachable to the image forming apparatus 1. This can be achieved by separating from the developing device 4 a photosensitive element unit into which the photosensitive element 2, the electrostatic charging unit that includes the charging roller 3, and the cleaning device that includes the cleaning blade 5 are combined. Alternatively, the developer housing unit 21 (toner container) and the agitator 25 can be separated from among the constituents of the developing device 4 illustrated in FIG. 2 to form a toner cartridge which is independent of the developing device 4. The toner cartridge can be configured to be singly detachably attachable to the image forming apparatus 1. In each of these cases, the developing device 4 or the toner cartridge is to be singly detached and recycled in a manner similar to those described above.

Application of the configuration of the present invention is not limited to the toner cartridge for housing toner therein, the developing device, and the process unit. The configuration is also applicable to a powder container that houses powder other than toner in its housing. More specifically, when a powder container that is to be mounted in an apparatus and includes an electronic or optical component that performs its function by exchanging an electrical or optical signal with the apparatus, operation advantage similar to that described above can be obtained by configuring the electronic or optical component to be detachably attachable in one piece with a cover member.

According to the embodiments, even when a powder container includes an electronic component such as an IC chip (IC tag), a piezoelectric sensor, or a magnetic sensor, sticking of powder or the like to the electronic component during cleaning of the housing can be prevented by detaching the electronic component in one piece with the cover member and storing it before the cleaning. This eliminates the need of additional cleaning of the electronic component soiled with powder or the like, thereby increasing efficiency in the cleaning. Furthermore, even when static electricity is built during the cleaning, the electronic component is unaffected by the static electricity and therefore will not become damaged. Accordingly, recycling can be performed efficiently.

Even when the powder container includes an optical component such as a light guide member, detaching the optical component in one piece with the cover member before cleaning of the housing is performed prevents the optical component from hindering the cleaning of the housing and powder filling, and therefore the cleaning and the powder filling are facilitated. As a result, efficiency in the cleaning and the powder filling is increased.

Thus, according to the embodiments, the electronic component or the optical component is detachable in one piece with the cover member from the housing. This enables easy and efficient recycling of the powder container.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

1: A powder container, comprising:
a housing configured to house powder therein, the housing having a hole connecting between inside and outside of the housing;
a cover member detachably attached to the housing to close the hole; and
a signal exchanging unit configured to transmit and receive a signal to and from an apparatus to which the powder container is mounted, the signal exchanging unit being provided in the cover member, wherein
the housing includes a holder having a pair of grooves into which the cover member can be inserted,
the cover member is provided with a seal on a surface of the cover member that faces the housing, and
a resilience of the seal presses the cover member against the grooves.

2: The powder container according to claim 1, wherein the signal exchanging unit is an information storage medium configured to transmit and receive an electrical signal to and from the apparatus.

3: The powder container according to claim 2, wherein the information storage medium is an IC chip that is electrically connectable to an information reader via a connecting terminal, the information reader being provided in the apparatus.

4-5. (canceled)

6: The powder container according to claim 1, wherein the powder is toner.

7: A toner cartridge detachably mounted in an image forming apparatus, the toner cartridge comprising the powder container according to claim 1, the powder being toner.

8: A developing device detachably mounted in an image forming apparatus, the developing device comprising:
a powder container according to claim 1, the powder being toner; and
a developing unit configured to develop a latent image on a latent image carrier using the toner in the powder container.

9: A process unit detachably mounted on an image forming apparatus, the process unit comprising:
a latent image carrier configured to carry a latent image thereon;
a powder container according to claim 1, the powder being toner; and
a developing unit configured to develop a latent image on the latent image carrier using the toner in the powder container.

10: An image forming apparatus comprising the powder container according to claim 1, the powder being toner.

11: An image forming apparatus comprising a toner cartridge according to claim 7.

12: An image forming apparatus comprising a developing device according to claim 8.

13: An image forming apparatus comprising a process unit according to claim 9.

14: A method for recycling a powder container that includes a housing configured to house powder therein, the housing having a hole connecting between inside and outside of the housing, a cover member detachably attached to the housing to close the hole, and a signal exchanging unit configured to transmit and receive a signal to and from an apparatus to which the powder container is mounted, the signal exchanging unit being provided in the cover member, the housing including a holder having a pair of grooves into which the cover member can be inserted, the cover member being provided with a seal on a surface of the cover member that faces the housing, and a resilience of the seal pressing the cover member against the grooves, the method comprising:
detaching the cover member from the exhausted powder container;
cleaning inside the housing;
filling the housing with powder through the hole; and
closing the hole with the cover member.
